(19) United States
(12) Patent Application Publication
(10) Pub. No.: US 2006/0089152 A1
(43) Pub. Date: Apr. 27, 2006

(54) Location-based synchronization of mobile terminals

(75) Inventor: Hannu Mahonen, Tampere (FI)

Correspondence Address: WARE FRESSOLA VAN DER SLUYS &;ADOLPHSON, LLP, BRADFORD GREEN BUILDING 5, 755 MAIN STREET, P O BOX 224, MONROE, CT, 06468, US

(73) Assignee: Nokia Corporation

(21) Appl. No.: 10/976,021

(22) Filed: Oct. 27, 2004

(51) Int. Cl. H04Q 7/20

(52) U.S. Cl. 455/456.1

(57) ABSTRACT

This invention describes a new methodology for a location-based synchronization of content in mobile terminals (e.g., wireless devices, portable devices, mobile communication devices, mobile phones, etc.). The present invention enables a new usage model for mobile terminals: it makes it possible to have the content of the mobile terminal be dependent on a current position/location of the mobile terminal. This will allow new exciting applications and services and thus new business opportunities. It can also be used for improving the usability of content applications.

### TECHNICAL FIELD

This invention generally relates to mobile devices and more specifically to location-based synchronization in mobile terminals.

### BACKGROUND ART

Data synchronization effectively means conceptually that there is the same object in multiple places at the same time. For instance, conceptually there is a calendar or a contact list present both in Microsoft® Outlook® of a personal computer (PC) and in a mobile phone (terminal). When the phone number of a contact on the PC is changed or a meeting moved to a later date, one expects, when synchronized, that the corresponding entries in the mobile phone are modified as well, not that new entries are created. A standard OMA DS (or an OMA data synchronization standard, formerly known as a SyncML) is a universal synchronization technology to the industry, enabling information exchange and synchronization between any mobile device and application over networks.

Mobile positioning technologies such as a GPS (global positioning system), a Bluetooth proximity or network cell ID based solutions allow location-based services for mobile terminal users. There are a lot of applications that may take advantage of location information, for example, digital maps, a route guidance and a location-based advertisement.

In data synchronization between servers and resource challenging mobile devices (terminals) some filtering mechanism is needed in order to limit the amount of data transferred from the server to a client (e.g., the mobile terminal) because of the inadequate capabilities of the mobile device (e.g., a low processing power, a low memory size, a small display size, etc.). In addition, some data can be irrelevant or cannot be used in mobile devices at all. The filtering may be based, for example, on a time window in the calendar (e.g., only next 3 days), on a size of emails (e.g., a maximum size 50 KB) or on categories of contacts (e.g., only business contacts).

Location-based services and data synchronization services are common but they have not been combined with each other so far, which is highly desirable and which is addressed by the present invention.

### DISCLOSURE OF THE INVENTION

The object of the present invention is to provide a methodology for location-based synchronization in mobile terminals (e.g., portable communication devices, mobile phones, personal computers, non-portable electronic devices installed on mobile platforms, etc.).

According to a first aspect of the invention, a method for a location-based synchronization in a mobile terminal, comprises the steps of: determining a location of the mobile terminal optionally containing a synchronization client; and providing, based on a predetermined criterion, by a server to the mobile terminal, optionally to the synchronization client of the mobile terminal, a sync server signal containing application content specific to the location, thus implementing the location-based synchronization.

Further according to the first aspect of the invention, the step of the determining of the location may contain determining the location of the mobile terminal at a start of a predetermined time interval and at an end of the predetermined time interval and the sync server signal may be provided only if a change of the location between the start and the end of the predetermined time interval exceeds a predefined distance.

Still further according to the first aspect of the invention, the sync server signal may be provided by the server using a one-way synchronization or a slow synchronization.

According further to the first aspect of the invention, before the step of the providing by the server the sync server signal, the method may comprise the step of: sending to the server by the mobile terminal optionally using the synchronization client a sync terminal signal requesting the application content for the mobile terminal specific to the location of the mobile terminal.

According still further to the first aspect of the invention, the method may further comprise the steps of: performing by the mobile terminal optionally using the synchronization client a data update using the application content contained in the sync server signal and sending to the server by the mobile terminal optionally using the synchronization client a data mapping signal optionally containing a modification processing report and ID mapping.

According further still to the first aspect of the invention, the location may be determined by the mobile terminal and after the step of the determining the location of the mobile terminal, the method may comprise the steps of: sending to the server by the mobile terminal optionally using the synchronization client an initialization terminal location signal containing the location, identification and authentication mobile terminal information and a mobile terminal synchronization type used by the mobile terminal, if a change of the location in a predetermined time interval exceeds a predefined distance; updating in the server by the server, in response to the initialization terminal location signal, the application content for the mobile terminal specific to the location and sending by the server to the mobile terminal, optionally to the synchronization client, an initialization server signal containing identification and authentication server information and a server synchronization type; and sending to the server by the mobile terminal, optionally using the synchronization client, a sync terminal signal requesting the application content for the mobile terminal specific to the location of the mobile terminal in response to the initialization server signal. Still further, the location may be determined by the server and after the step of the determining the location of the mobile terminal, the method may comprise the steps of: updating in the server by the server the application content for the mobile terminal specific to the location and sending by the server to the mobile terminal, optionally to the synchronization client, a server alert signal, if a change of the location in a predetermined time interval exceeds a predefined distance; sending to the server by the mobile terminal optionally using the synchronization client an initialization terminal signal containing identification and authentication mobile terminal information and a mobile terminal synchronization type used by the mobile terminal in response to the server alert signal; sending to the mobile terminal, optionally to the synchronization client, by the server an initialization server signal containing identification and authentication server information and a server synchronization type in response to the initialization terminal signal, and sending to the server by the mobile terminal optionally using the synchronization client a sync terminal signal requesting the application content for the mobile terminal specific to the location of the mobile terminal, if content of the initialization terminal signal and the initialization terminal signal conforms to a predetermined protocol.

According to a second aspect of the invention, a mobile terminal capable of a location-based synchronization, comprising: a synchronization client, responsive to an application content signal containing application content specific to a location of the mobile terminal, thus implementing the location-based synchronization; a receiving/transmitting/processing module, responsive to a sync server signal containing the application content and converting the sync server signal to the application content signal, for providing the application content signal to the synchronization client, wherein the sync server signal is provided by a server based on determining the location and using a predetermined criterion.

According further to the second aspect of the invention, the mobile terminal may further comprise means for determining the location of the mobile terminal.

Further according to the second aspect of the invention, the sync server signal is provided by the server using a one-way synchronization or a slow synchronization.

Still further according to the second aspect of the invention, before the providing by the server the sync server signal, the synchronization client may generate a request application content signal requesting the application content for the mobile terminal specific to the location of the mobile terminal and the request application content signal may be converted to a sync terminal signal and transmitted to the server by the receiving/transmitting/processing module.

According further to the second aspect of the invention, in response to sync server signal, the mobile terminal may perform a data update using the application content contained in the sync server signal. Still further, the data update may be performed by the synchronization client by transferring the application content specific to the mobile terminal location to a memory. Yet still further, after the data update, the mobile terminal, optionally using the synchronization client, may send a data mapping signal to the server optionally containing a modification processing report and ID mapping.

According still further to the second aspect of the invention, the determining of the location may include determining the location of the mobile terminal at a start of a predetermined time interval and at an end of the predetermined time interval and the sync server signal may be provided only if a change of the location between the start and the end of the predetermined time interval exceeds a predefined distance.

According further still to the second aspect of the invention, the mobile terminal of claim may further comprise: a memory, for storing the application content specific to the mobile terminal location.

According yet further still to the second aspect of the invention, the mobile terminal may be a wireless device, a portable device, a mobile communication device, a mobile phone or a non-portable electronic device installed on a mobile platform.

According to a third aspect of the invention, a communication system capable of a location-based synchronization, comprises: a mobile terminal, responsive to a sync server signal containing an application content for the mobile terminal specific to the location, thus implementing the location-based synchronization in the mobile terminal; and a server, for providing the sync server signal.

According further to the third aspect of the invention, the determining of the location may include determining the location of the mobile terminal at a start of a predetermined time interval and at an end of the predetermined time interval and the sync server signal may be provided only if a change of the location between the start and the end of the predetermined time interval exceeds a predefined distance.

Further according to the third aspect of the invention, the sync server signal may be provided by the server using a one-way synchronization or a slow synchronization.

Still further according to the third aspect of the invention, before the sync server signal is provided by the server, the mobile terminal may provide to the server a sync terminal signal requesting the application content for the mobile terminal specific to the location.

According further to the third aspect of the invention, the mobile terminal may be further for performing a data update using the application content contained in the sync server signal and for providing to the server a data mapping signal optionally containing a modification processing report and ID mapping.

According still further to the third aspect of the invention, the location of the mobile terminal may be determined by the mobile terminal or by the server.

According to a fourth aspect of the invention, a computer readable storage structure embodying computer program code thereon for execution by a computer processor with the computer program code characterized in that it includes instructions for performing the steps of the first aspect of the invention indicated as being performed by any component or a combination of components of the mobile device or the server or performed by any component or a combination of components of the mobile device and the server.

Benefits of using the location-based synchronization in mobile terminals include (but may not be limited to):

usability: it is possible to create applications and services that contain only the information that is relevant for the current location of the mobile terminal (i.e., the user of the terminal);

attracting people: it is possible to create new applications and services so that only the relevant content is distributed, and thus underlining the importance of the content at a given location and at a certain time; and

promoting: location-based content promotes profitability of local businesses (e.g., shops, events) and creates promising business opportunities for all parties in the industry.

### BRIEF DESCRIPTION OF THE DRAWINGS

For a better understanding of the nature and objects of the present invention, reference is made to the following detailed description taken in conjunction with the following drawings, in which:

FIG. 1a is a system block diagram demonstrating a location-based synchronization in a mobile terminal, according to the present invention;

FIG. 1b is a block diagram of a mobile terminal for implementing a location-based synchronization, according to the present invention;

FIG. 2 is a diagram presenting different phases of a synchronization protocol using an OMA DS, according to the present invention;

FIG. 3 is a flow chart demonstrating a location-based synchronization in a mobile terminal initiated by a client (the mobile terminal), according to the present invention; and

FIG. 4 is a flow chart demonstrating a location-based synchronization in a mobile terminal initiated by a server, according to the present invention.

### BEST MODE FOR CARRYING OUT THE INVENTION

The present invention provides a new methodology for a location-based synchronization of content in mobile terminals such as wireless devices, portable devices, mobile communication devices, mobile phones, non-portable electronic devices installed on a mobile platform, etc.).

This invention enables a new usage model for mobile terminals: it makes it possible to have the content of the mobile terminal be dependent on a current position/location of the mobile terminal (among other contextual data such as time and available connections). This will allow new exciting applications and services and thus new business opportunities. It can also be used for improving the usability of content applications.

According to the present invention, the data synchronization services in mobile terminals enable:

synchronization of the content including but not limited to contacts, calendar, tasks, emails, and note texts; images and other multimedia files;

synchronization session initiated by a client (mobile terminal) implementing a client initiated synchronization or initiated by a server implementing a server alerted synchronization; and

one-way synchronization from the server to the client.

According to the present invention, a client (mobile terminal) initiated synchronization for updating application content of the mobile terminal incorporates the following features:
1. During a start-up, and at frequent predetermined time intervals (continuously), the client determines the terminal's position (location); there are a number of various methods for the position determination which can be used, including currently available techniques, like GPS, Network location servers (e.g. Gateway Mobile Location Server, GMLS) or Cell ID based systems and other fast emerging technologies;
2. If the mobile terminal location has changed by more than a predefined distance during any of the time intervals, the terminal initiates a synchronization session with a server at the end of that time interval; in the synchronization initiation phase (package), the client provides the terminal position as a parameter to the server; in general it can be useful to deliver supporting information in the initiation package to indicate what content to be synchronized from the server to the client one-way; in addition or instead of the one-way synchronization type, one-way refresh synchronization type can be also used in some cases, wherein the initiation package for the one-way refresh synchronization should contain similar information as for the one-way synchronization; and
3. The server updates the application content on the server side, and then sends changes to the client (e.g., one-way sync from the server to the client, slow sync in case of a first time, etc.).

There are a number of different technologies (mentioned above) for determining the terminal's position (location) using position-determining equipment (PDE). In general, PDE technology can utilize one of three formats:
1) Cell Identification Technology, where high levels of location accuracy are neither mandatory, nor necessary to deliver wireless location services; utilizing an operator's existing network infrastructure, the technology determines the position of a caller to the nearest cell; SIM Toolkit allows compliant handsets to be upgraded to support new value added services on an ad hoc basis;
2) Network-based Triangulation Technology, which determines a callers' location by applying mathematical algorithms to the attributes of RF signals (timing, phase, amplitude, etc.) received at the cell sites; requires additional hardware and software at the base station; and
3) Handset-based Triangulation Technology, which determines a caller's location by accessing a separate location network, usually either GPS (global positioning system) or Differential GPS (DGPS). This approach requires a software and/or hardware modification to the phone, as well as the deployment of additional infrastructure, in the case of DGPS.

According to the present invention, a server initiated synchronization for updating the application content of the mobile terminal incorporates the following features:
1. The server determines the terminal's position (location) at frequent predetermined time intervals (continuously); for example, the server can get a cell identifier from the cellular network or it can request the position from the mobile terminal or it can use services of network location servers;
2. If the terminal location has changed by more than the predefined distance during any of the time intervals, the server updates the application content residing on the server side, and then sends a server alert message to the client; and
3. The client (mobile terminal) initiates the synchronization session and the server sends changes to the client (e.g., the one-way sync from the server to the client, the slow sync in the case of first time, etc.).

Several examples of location-based applications are provided below.

Case 1: a location-based Event Calendar application; when a mobile terminal user is at home, the Event Calendar application contains only the events that take place in his/her hometown. When the user visits another city, the content of the application is updated correspondingly.

Case 2: a location-based Yellow Pages application; when the mobile terminal user is at home, the Yellow Pages application contains only information on local businesses. When the user visits another city, the content of the application is updated correspondingly.

Case 3: the user may also have multiple applications each of which is dedicated to a certain location, for example, Helsinki Event Calendar, Tampere Event Calendar and Tampere Yellow Pages; whenever the mobile terminal location changes, only the corresponding application is updated.

Case 4: a map application for vehicles; a car includes the positioning system and a map application; when the location of the car is changed, the application is synchronizing the map of the current location and possibly a nearby area based on, e.g., the current vehicle direction and speed, for example.

From the implementation point of view, the present invention only requires an API (application programming interface) by which the application developer can provide the location checking routines. For example, API for data synchronization routines already exists in the Symbian software platforms which can provide the applications with the available means to initiate a synchronization session with a remote server if necessary.

As discussed above, the initiation of the synchronization session can be triggered either on the mobile terminal side (client initiated sync) or on the server side (server alerted sync). A particular approach can be utilized depending on the Location Framework and positioning technologies available. Also, for implementing the location-based synchronization, at least the content residing on the server side must contain position (location) information, i.e., the calendar events, contacts, etc. (stored in the server) should have position (location) properties attached.

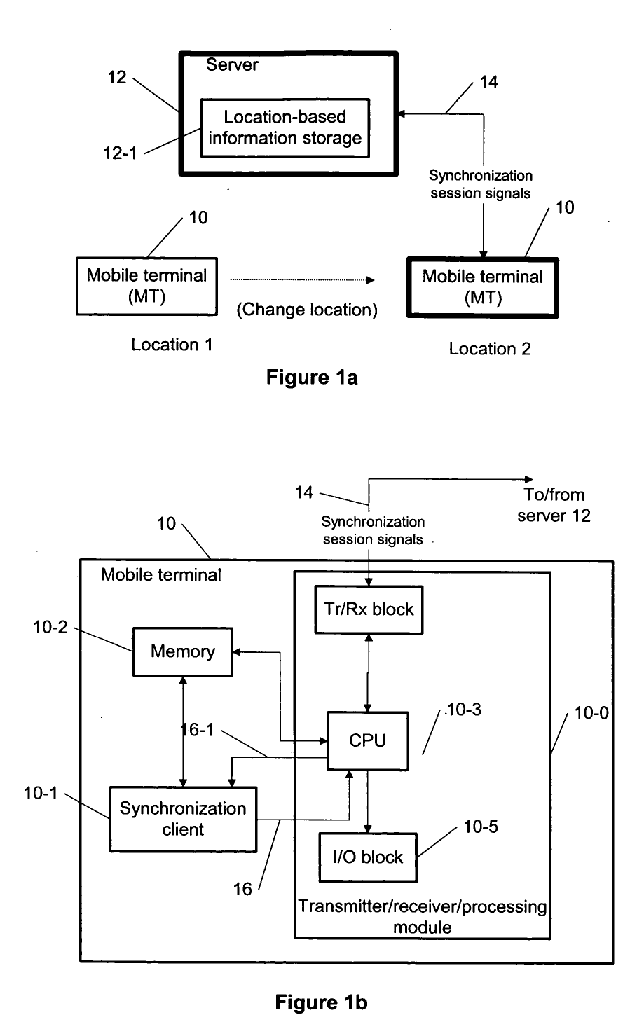

FIG. 1a shows an example, among others, of a system block diagram demonstrating a location-based synchronization in a mobile terminal 10, according to the present invention. The mobile terminal 10 changes its location from a first location (location 1) at a start of the predetermined time interval to a second location (location 2) at an end of the predetermined time interval. The location of the mobile terminal 10 can be determined by the mobile terminal directly or by the server 12 as described above. If it is determined that a distance between the first and the second locations exceeds a predefined distance during the predetermined time interval, a location-based synchronization in a mobile terminal 10 is initiated and the server 12 updates application content of the mobile terminal using a synchronization protocol facilitated by synchronization session signals 14. To further facilitate this update, the server 12 contains a location-based information storage module 12-1, wherein the stored application content information has position (location) information attached.

FIG. 1b shows an example among many others of a mobile terminal 10 block diagram for implementing a location-based synchronization, according to the present invention. The key element is a synchronization client 10-1 which is primarily responsible for coordinating and performing said location-based synchronization in said mobile terminal 10. The synchronization session signals 14 transmitted and received by a Tr/Rx block 10-4 to/from the server 12 are originated and coordinated by the synchronization client 10-1 using standard signal processing procedures involving, e.g., a CPU 10-3, a memory 10-2 and an I/O block 10-5. Block 10-3, 10-4 and 10-5 are contained in a transmitter/receiver/processing block 10-0 which can be implemented in a plurality of ways, as well known in the art. Thus, the synchronization session signals 14 are provided to/from the synchronization client 10-1 (shown, e.g., as an application content signal 16-1 or a request application content signal 16) by the transmitter/receiver/processing block 10-0. According to the present invention, the synchronization client 10-1 can be implemented in a variety of ways as a software, hardware or a combination thereof; it can contain means (software or hardware) for performing its locations determination as described above, or it can be a part of the transmitter/receiver/processing block 10-0. Also, the location determination can be performed by other blocks of the mobile terminal 10 (not shown in FIG. 1b).

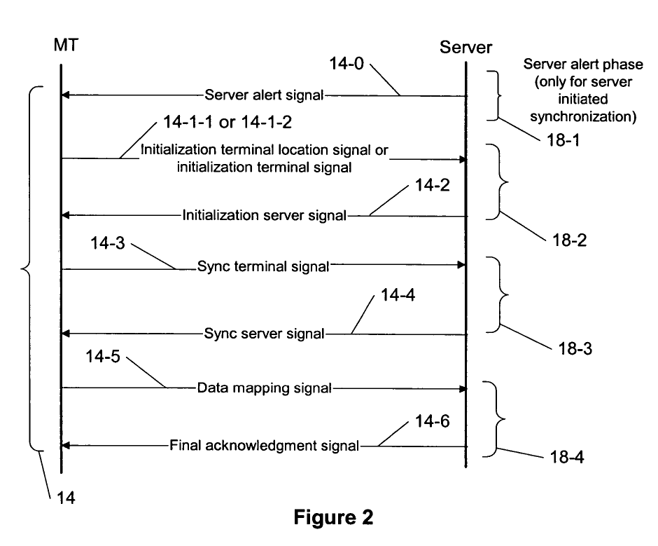

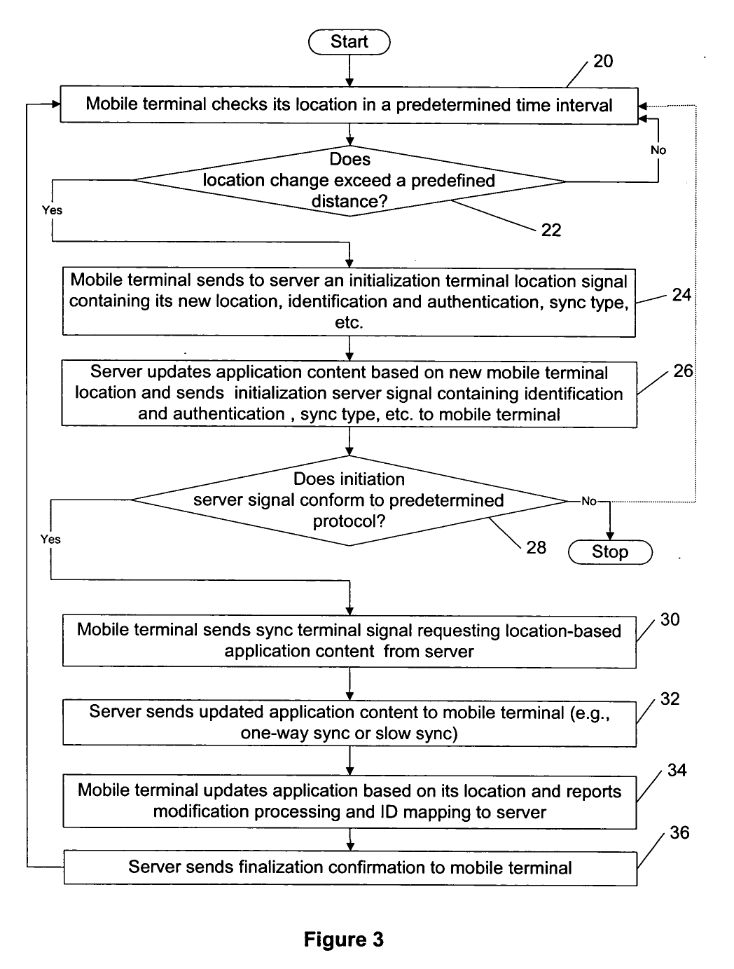

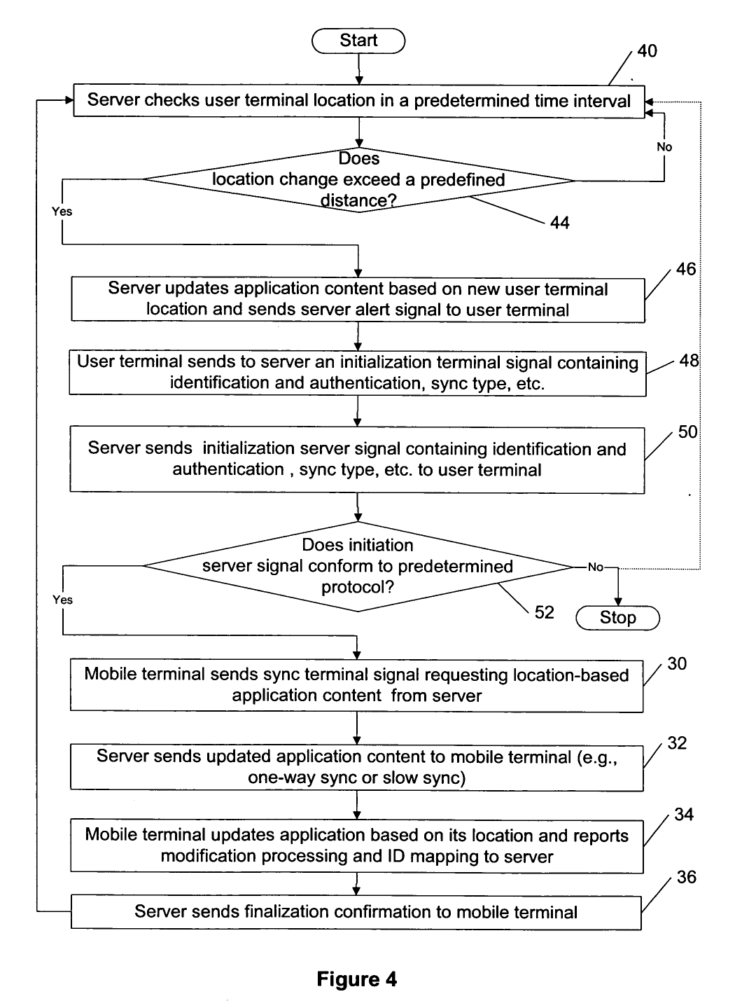

FIG. 2 shows an example among others of a diagram presenting different phases of a synchronization protocol using an OMA data sync, according to the present invention. The protocol can have four phases implemented using the synchronization session signals 14. A server alert phase 18-1 (only for the server initiated synchronization) is represented by a server alert signal 14-0 sent by the server 12 to the mobile terminal 10. An initiation phase 18-2 is represented by an initialization terminal location signal 14-1-1 (for the terminal initiated synchronization) or by an initialization terminal signal 14-1-2 (for the server initiated synchronization), both sent by the mobile terminal 10 to the server 12. The initiation phase 18-2 is further represented by an initialization server signal 14-2 sent by the server 12 to the mobile terminal 10. A data exchange phase 18-3 is represented by a sync terminal signal 14-3 sent by the mobile terminal 10 to the server 12 followed by a server signal 14-4 sent by the server 12 to the mobile terminal 10. Finally, a completion phase 18-4 is represented by a data mapping signal 14-5 sent by the mobile terminal 10 to the server 12 followed by a final acknowledgment signal 14-6 sent by the server 12 to the mobile terminal 10. More details about the phases 18-1 through 18-4 and the signals 14-1 through 14-6 are provided below in reference to FIGS. 3 and 4.

FIG. 3 shows an example of a flow chart demonstrating the location-based synchronization in the mobile terminal 10 initiated by the client (the mobile terminal 10), according to the present invention; and

The flow chart of FIG. 3 only represents one possible scenario among many others. In a method according to the present invention, in a first step 20, the mobile terminal 10 determines its location at the start of the predetermined time interval and at the end of the predetermined time interval as described above.

In a next step 22, it is determined whether a change of the location between the start and the end of said predetermined time interval exceeds the predefined distance (e.g., set up in advance by a system operator or by the user of the mobile terminal 10). If that is not the case, the process goes back to step 20 for continuing determination of the location of the mobile terminal 10. If, however, the mobile terminal 10 determines that the change of the location between the start and the end of said predetermined time interval exceeds the predefined distance, in a next step 24, the mobile terminal 10 sends to the server 12 the initialization terminal location signal 14-1-1 containing the location of the mobile terminal 10 at the end of said predetermined time period, identification and authentication mobile terminal information, a mobile terminal synchronization type used by the mobile terminal 10 and possibly a conformity check of a previous synchronization session. In a next step 26, in response to the initialization terminal location signal 14-1-1, the server 12 updates the application content for the mobile terminal 10 specific to the determined location at the end of said predetermined time period (e.g., using the location-based information storage module 12-1) and sends to said mobile terminal 10 the initialization server signal 14-2 containing identification and authentication server information, a server synchronization type and possibly a confirmation of the conformity check of the previous synchronization session

In a next step 28, it is determined by the mobile terminal 12 whether the content of the initialization terminal location signal 14-1-1 and the initialization server signal 14-2 conform to a predetermined protocol. If that is not the case, the process goes back to step 20. If, however, the mobile terminal 12 determines that the content of the initialization terminal location signal 14-1-1 and the initialization server 14-2 conforms to a predetermined protocol, in a next step 30, the mobile terminal 10 sends to the server 12 the sync terminal signal 14-3 requesting the application content for the mobile terminal 10 specific to the location at the end of said predetermined time period of the mobile terminal 10. In a next step 32, the server 12 sends to said mobile terminal 10 the sync terminal signal 14-4 containing the requested application content for said mobile terminal 10 specific to said location at the end of said predetermined time period of the mobile terminal 10.

In a next step 34, the mobile terminal 10 performs modifications of its own applications using the application content contained in the sync server signal 14-4 and sends to the server a data mapping signal 14-5 containing a modification processing report and an ID mapping. Finally, in a next step 36, the server 12 sends to said mobile terminal 10 a final acknowledgement signal 14-6 containing finalization confirmation.

FIG. 4 shows an example of a flow chart demonstrating the location-based synchronization in the mobile terminal 10 initiated by the server 12, according to the present invention.

The flow chart of FIG. 4 only represents one possible scenario among many others. In a method according to the present invention, in a first step 40, the server 12 determines the location of the mobile terminal 10 at the start of the predetermined time interval and at the end of the predetermined time interval as described above.

In a next step 44, it is determined whether the change of the location between the start and the end of said predetermined time interval exceeds the predefined distance (e.g., set up in advance by a system operator or by a user of the mobile terminal 10). If that is not the case, the process stops or alternatively goes back to step 40 for continuing determination of the mobile terminal location. If, however, the server 12 determines that the change of the location between the start and the end of said predetermined time interval exceeds the predefined distance, in a next step 46, the server 12 updates the application content for the mobile terminal 10 specific to the determined location at the end of said predetermined time period (e.g., using the location-based information storage module 12-1) and sends to said mobile terminal 10 the server alert signal 14-0. In a next step 48, in response to the server alert signal 14-0, the mobile terminal 10 sends to the server 12 the initialization terminal signal 14-1-2 containing the identification and authentication mobile terminal information, the mobile terminal synchronization type used by the mobile terminal 10 and possibly the conformity check of the previous synchronization session. In a next step 50, in response to the initialization terminal signal 14-1-2, the server 12 sends to said mobile terminal 10 the initialization server signal 14-2 containing the identification and authentication server information, the server synchronization type and possibly the confirmation of the conformity check of a previous synchronization session.

In a next step 52, it is determined by the mobile terminal 12 whether the content of the initialization terminal signal 14-1-2 and the initialization server signal 14-2 conform to a predetermined protocol. If that is not the case, the process stops or alternatively goes back to step 40. If, however, the mobile terminal 12 determines that the content of the initialization terminal signal 14-1-2 and the initialization server signal 14-2 conforms to a predetermined protocol, the process goes to step 30 which is already described in regard to FIG. 3. The next three steps 32, 34 and 36 are identical to the same steps described in regard to FIG. 3.

While particular embodiments of the present invention have been disclosed, it is to be understood that various different modifications and combinations are possible and are contemplated within the true spirit and scope of the appended claims. There is no intention, therefore, of limitations to the exact abstract and disclosure herein presented.

What is claimed is:

1. A method for a location-based synchronization in a mobile terminal, comprising the steps of:
determining a location of said mobile terminal optionally containing a synchronization client; and
providing, based on a predetermined criterion, by a server to said mobile terminal, optionally to said synchronization client of said mobile terminal, a sync server signal containing application content specific to said location, thus implementing said location-based synchronization.

2. The method of claim 1, wherein said step of said determining of said location contains determining the location of the mobile terminal at a start of a predetermined time interval and at an end of said predetermined time interval and said sync server signal is provided only if a change of said location between the start and the end of said predetermined time interval exceeds a predefined distance.

3. The method of claim 1, wherein said sync server signal is provided by said server using a one-way synchronization or a slow synchronization.

4. The method of claim 1, wherein before the step of said providing by said server said sync server signal, the method comprises the step of:
sending to said server by said mobile terminal optionally using said synchronization client a sync terminal signal requesting said application content for said mobile terminal specific to said location of said mobile terminal.

5. The method of claim 1, further comprises the steps of:
performing by said mobile terminal optionally using said synchronization client a data update using said application content contained in said sync server signal and sending to said server by said mobile terminal optionally using said synchronization client a data mapping signal optionally containing a modification processing report and ID mapping.

6. The method of claim 1, wherein said location is determined by said mobile terminal or by said server.

7. The method of claim 6, wherein said location is determined by said mobile terminal and after the step of said determining said location of the mobile terminal, the method comprises the steps of:
sending to said server by said mobile terminal optionally using said synchronization client an initialization terminal location signal containing said location, identification and authentication mobile terminal information and a mobile terminal synchronization type used by the mobile terminal, if a change of said location in a predetermined time interval exceeds a predefined distance;
updating in said server by said server, in response to said initialization terminal location signal, said application content for said mobile terminal specific to said location and sending by said server to said mobile terminal, optionally to said synchronization client, an initialization server signal containing identification and authentication server information and a server synchronization type; and
sending to said server by said mobile terminal optionally using said synchronization client a sync terminal signal requesting said application content for said mobile terminal specific to said location of said mobile terminal in response to said initialization server signal.

8. The method of claim 6, wherein said location is determined by said server and after the step of said determining said location of the mobile terminal, the method comprises the steps of:
updating in said server by said server said application content for said mobile terminal specific to said location and sending by said server to said mobile terminal, optionally to said synchronization client, a server alert signal, if a change of said location in a predetermined time interval exceeds a predefined distance;
sending to said server by said mobile terminal optionally using said synchronization client an initialization terminal signal containing identification and authentication mobile terminal information and a mobile terminal synchronization type used by the mobile terminal in response to said server alert signal;
sending to said mobile terminal, optionally to said synchronization client, by said server an initialization server signal containing identification and authentication server information and a server synchronization type in response to said initialization terminal signal, and
sending to said server by said mobile terminal optionally using said synchronization client a sync terminal signal requesting said application content for said mobile terminal specific to said location of said mobile terminal, if content of said initialization terminal signal and said initialization terminal signal conforms to a predetermined protocol.

9. A computer program product comprising: a computer readable storage structure embodying computer program code thereon for execution by a computer processor with said computer program code characterized in that it includes instructions for performing the steps of the method of claim 1 indicated as being performed by any component or a combination of components of said mobile device or said server or performed by any component or a combination of components of said mobile device and said server.

10. A mobile terminal capable of a location-based synchronization, comprising:
a synchronization client, responsive to an application content signal containing application content specific to a location of said mobile terminal, thus implementing said location-based synchronization;
a receiving/transmitting/processing module, responsive to a sync server signal containing said application content and converting said sync server signal to said application content signal, for providing said application content signal to said synchronization client,
wherein said sync server signal is provided by a server based on determining said location and using a predetermined criterion.

11. The mobile terminal of claim 10, further comprises means for determining said location of said mobile terminal.

12. The mobile terminal of claim 10, wherein said sync server signal is provided by said server using a one-way synchronization or a slow synchronization.

13. The mobile terminal of claim 10, wherein before said providing by said server said sync server signal, said synchronization client generates a request application content signal requesting said application content for said mobile terminal specific to said location of said mobile terminal and said request application content signal is converted to a sync terminal signal and transmitted to said server by said receiving/transmitting/processing module.

14. The mobile terminal of claim 10, wherein in response to sync server signal said mobile terminal performs a data update using said application content contained in said sync server signal.

15. The mobile terminal of claim 14, wherein said data update is performed by said synchronization client by transferring said application content specific to said mobile terminal location to a memory.

16. The mobile terminal of claim 15, wherein after said data update said mobile terminal optionally using said synchronization client sends a data mapping signal to said server optionally containing a modification processing report and ID mapping.

17. The mobile terminal of claim 10, wherein said determining of said location includes determining the location of the mobile terminal at a start of a predetermined time interval and at an end of said predetermined time interval and said sync server signal is provided only if a change of said location between the start and the end of said predetermined time interval exceeds a predefined distance.

18. The mobile terminal of claim 10, further comprising:
a memory, for storing said application content specific to said mobile terminal location.

19. The mobile terminal of claim 10, wherein said mobile terminal is a wireless device, a portable device, a mobile communication device, a mobile phone or a non-portable electronic device installed on a mobile platform.

20. A communication system capable of a location-based synchronization, comprising:
a mobile terminal, responsive to a sync server signal containing an application content for said mobile terminal specific to said location, thus implementing said location-based synchronization in said mobile terminal; and
a server, for providing said sync server signal.

21. The communication system of claim 20, wherein said determining of said location includes determining the location of the mobile terminal at a start of a predetermined time interval and at an end of said predetermined time interval and said sync server signal is provided only if a change of said location between the start and the end of said predetermined time interval exceeds a predefined distance.

22. The communication system of claim 20, wherein said sync server signal is provided by said server using a one-way synchronization or a slow synchronization.

23. The communication system of claim 20, wherein before said sync server signal is provided by said server, the mobile terminal provides to said server a sync terminal signal requesting said application content for said mobile terminal specific to said location.

24. The communication system of claim 20, wherein said mobile terminal is further for performing a data update using said application content contained in said sync server signal and for providing to said server a data mapping signal optionally containing a modification processing report and ID mapping.

25. The communication system of claim 20, wherein said location of the mobile terminal is determined by said mobile terminal or by said server.
